(19) United States
(12) Patent Application Publication
(10) Pub. No.: US 2022/0252306 A1
(43) Pub. Date: Aug. 11, 2022

(54) SERIES FLOW CHILLER SYSTEM

(71) Applicant: Johnson Controls Tyco IP Holdings LLP, Milwaukee, WI (US)

(72) Inventor: William Leslie Kopko, Jacobus, PA (US)

(21) Appl. No.: 17/627,095

(22) PCT Filed: Jul. 14, 2020
(86) PCT No.: PCT/US2020/041974

§ 371 Date: Jan. 13, 2022

Related U.S. Application Data
(60) Provisional application No. 62/874,396, filed on Jul. 15, 2019.

(51) Int. Cl. F25B 5/02; F25B 25/00

(52) U.S. Cl. CPC F25B 5/02; F25B 2400/06; F25B 25/005

(57) ABSTRACT

A heating, ventilation, air conditioning, and/or refrigeration (HVAC&R) system includes a first refrigerant circuit having a first compressor configured to circulate a first refrigerant through a first condenser and a first evaporator, a second refrigerant circuit having a second compressor configured to circulate a second refrigerant through a second condenser and a second evaporator, and a heat exchanger configured to place the first refrigerant in a heat exchange relationship with the second refrigerant. The first refrigerant circuit is configured to direct the first refrigerant from the first condenser to the heat exchanger and from the heat exchanger to the first evaporator, and the second refrigerant circuit is configured to direct the second refrigerant from the second condenser to the heat exchanger and from the heat exchanger to the second evaporator.

### CROSS REFERENCE TO RELATED APPLICATION

This application claims priority from and the benefit of U.S. Provisional Application Ser. No. 62/874,396, entitled “SERIES FLOW CHILLER SYSTEM,” filed Jul. 15, 2019, which is hereby incorporated by reference in its entirety for all purposes.

### BACKGROUND

This section is intended to introduce the reader to various aspects of art that may be related to various aspects of the present disclosure, which are described below. This discussion is believed to be helpful in providing the reader with background information to facilitate a better understanding of the various aspects of the present disclosure. Accordingly, it should be understood that these statements are to be read in this light, and not as admissions of prior art.

Chiller systems, or vapor compression systems, utilize a working fluid (e.g., a refrigerant) that changes phases between vapor, liquid, and combinations thereof, in response to exposure to different temperatures and pressures within components of the chiller system. The chiller system may place the working fluid in a heat exchange relationship with a conditioning fluid and may deliver the conditioning fluid to condition equipment and/or an environment of the chiller system. In some cases, a heating, ventilation, air conditioning, and/or refrigeration (HVAC&R) system may include multiple vapor compression systems, in which each vapor compression system circulates a respective working fluid. The respective working fluid may remove thermal energy from a flow of conditioning fluid that is in a heat exchange relationship with the respective working fluid via a component (e.g., an evaporator) of the vapor compression system. In such embodiments, each chiller system may also have a condenser configured to cool heated working fluid. For example, a cooling fluid may be directed through the respective condenser of each chiller system in a series arrangement to cool the respective working fluids. However, a flow arrangement of the cooling fluid through the condensers may limit an overall cooling capacity of the working fluid.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a heating, ventilation, air conditioning, and/or refrigeration (HVAC&R) system includes a first refrigerant circuit having a first compressor configured to circulate a first refrigerant through a first condenser and a first evaporator, a second refrigerant circuit having a second compressor configured to circulate a second refrigerant through a second condenser and a second evaporator, and a heat exchanger configured to place the first refrigerant in a heat exchange relationship with the second refrigerant. The first refrigerant circuit is configured to direct the first refrigerant from the first condenser to the heat exchanger and from the heat exchanger to the first evaporator, and the second refrigerant circuit is configured to direct the second refrigerant from the second condenser to the heat exchanger and from the heat exchanger to the second evaporator.

In another embodiment, a heating, ventilation, air conditioning, and/or refrigeration (HVAC&R) system includes a first refrigerant circuit configured to circulate a first refrigerant and a second refrigerant circuit configured to circulate a second refrigerant. The first refrigerant circuit includes a first evaporator configured to place the first refrigerant in a first heat exchange relationship with a conditioning fluid and the second refrigerant circuit includes a second evaporator configured to place the second refrigerant in a second heat exchange relationship with the conditioning fluid. The HVAC&R system further includes a heat exchanger configured to place the second refrigerant in a third heat exchange relationship with the conditioning fluid discharged from the first evaporator.

In another embodiment, a heating, ventilation, air conditioning, and/or refrigeration (HVAC&R) system includes a first refrigerant circuit configured to circulate a first refrigerant and place the first refrigerant in a first heat exchange relationship with a conditioning fluid, and a second refrigerant circuit configured to circulate a second refrigerant and configured to place the second refrigerant in a second heat exchange relationship with the conditioning fluid, in which the first refrigerant circuit and the second refrigerant circuit are fluidly separate from one another relative to a first flow of the first refrigerant and a second flow of the second refrigerant. The HVAC&R system further includes one or more heat exchangers configured to place the second refrigerant in a third heat exchange relationship with the conditioning fluid, the first refrigerant, or both.

### DRAWINGS

Various aspects of this disclosure may be better understood upon reading the following detailed description and upon reference to the drawings in which:

FIG. 1 is a perspective view of a building that may utilize an embodiment of a heating, ventilation, air conditioning, and/or refrigeration (HVAC&R) system in a commercial setting, in accordance with an aspect of the present disclosure;

FIG. 2 is a perspective view of an embodiment of a vapor compression system, in accordance with an aspect of the present disclosure;

FIG. 3 is a schematic of an embodiment of the vapor compression system of FIG. 2, in accordance with an aspect of the present disclosure;

FIG. 4 is a schematic of another embodiment of the vapor compression system of FIG. 2, in accordance with an aspect of the present disclosure;

FIG. 5 is a schematic of an embodiment of an HVAC&R system having a first refrigerant circuit and a second refrigerant circuit, illustrating a subcooling heat exchanger of the first refrigerant circuit configured to improve a performance of the HVAC&R system, in accordance with an aspect of the present disclosure;

FIG. 6 is a schematic of another embodiment of the HVAC&R system having the first refrigerant circuit, the second refrigerant circuit, and the subcooling heat exchanger, in accordance with an aspect of the present disclosure;

FIG. 7 is a schematic of another embodiment of the HVAC&R system having the first refrigerant circuit, the second refrigerant circuit, and the subcooling heat exchanger, in accordance with an aspect of the present disclosure;

FIG. 8 is a schematic of another embodiment of the HVAC&R system having the first refrigerant circuit, the second refrigerant circuit, and the subcooling heat exchanger, in accordance with an aspect of the present disclosure;

FIG. 9 is a block diagram illustrating an embodiment of a method of operating the HVAC&R system of FIG. 7, in accordance with an aspect of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Embodiments of the present disclosure relate to an HVAC&R system having multiple vapor compression systems, in which a conditioning fluid is directed through a respective heat exchanger (e.g., an evaporator) of each vapor compression systems. Generally, implementing multiple vapor compression systems may increase a capacity of the HVAC&R system to cool the conditioning fluid as compared to HVAC&R systems using a single vapor compression system. For instance, a conditioning fluid may be directed through, and cooled, via multiple heat exchangers (e.g., evaporators) instead of a single heat exchanger. That is, the conditioning fluid may be in thermal communication with a respective working fluid, such as a refrigerant, flowing through each of the heat exchangers of the respective vapor compression systems. Although this disclosure primarily describes refrigerant as the working fluid circulating through the vapor compression systems to exchange thermal energy with the conditioning fluid, additional or alternative embodiments may use other types of working fluids, such as water.

In accordance with embodiments of the present disclosure, an HVAC&R system may include multiple vapor compression systems that are each configured to circulate a respective refrigerant to cool a conditioning fluid directed through the HVAC&R system. Each vapor compression system may include a heat exchanger, such as a condenser, that places the respective refrigerants in a heat exchange relationship, or in thermal communication, with a cooling fluid to remove thermal energy from, and thereby cool, the refrigerants, which enables the refrigerants to cool the conditioning fluid. In some cases, the respective heat exchangers receive the cooling fluid in a series arrangement. However, cooling of the refrigerants of the multiple vapor compression systems may limit the ability of the HVAC&R system to ultimately cool the conditioning fluid.

Accordingly, implementing an additional heat exchanger within the HVAC&R system may increase cooling of at least one of the refrigerants and, therefore, increase a cooling capacity of the HVAC&R system. For example, in some embodiments, the additional heat exchanger may place the respective refrigerants in a heat exchange relationship with one another. In other embodiments, the additional heat exchanger and respective evaporators of the multiple vapor compression systems may place at least one of the refrigerants in a series heat exchange relationship with the conditioning fluid. In general, the additional heat exchanger increases an amount of cooling for at least one of the refrigerants, which may enable the at least one refrigerant to remove a greater amount of thermal energy (e.g., heat) from the conditioning fluid. As such, including the additional heat exchanger may enhance a cooling capacity of the HVAC&R system by enabling a greater overall amount of heat to be removed from the conditioning fluid.

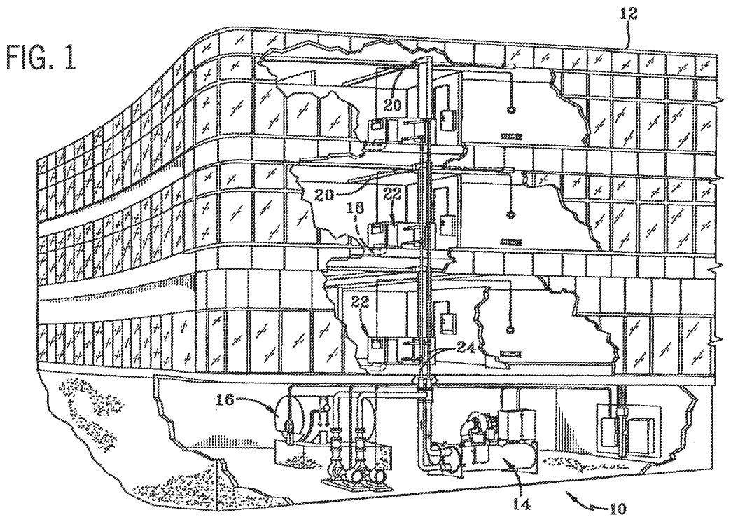

Turning now to the drawings, FIG. 1 is a perspective view of an embodiment of an environment for a heating, ventilation, air conditioning, and refrigeration (HVAC&R) system 10 in a building 12 for a typical commercial setting. The HVAC&R system 10 may include a vapor compression system 14 that supplies a chilled liquid, which may be used to cool the building 12. The HVAC&R system 10 may also include a boiler 16 to supply warm liquid to heat the building 12 and an air distribution system which circulates air through the building 12. The air distribution system can also include an air return duct 18, an air supply duct 20, and/or an air handler 22. In some embodiments, the air handler 22 may include a heat exchanger that is connected to the boiler 16 and the vapor compression system 14 by conduits 24. The heat exchanger in the air handler 22 may receive either heated liquid from the boiler 16 or chilled liquid from the vapor compression system 14, depending on the mode of operation of the HVAC&R system 10. The HVAC&R system 10 is shown with a separate air handler on each floor of building 12, but in other embodiments, the HVAC&R system 10 may include air handlers 22 and/or other components that may be shared between or among floors.

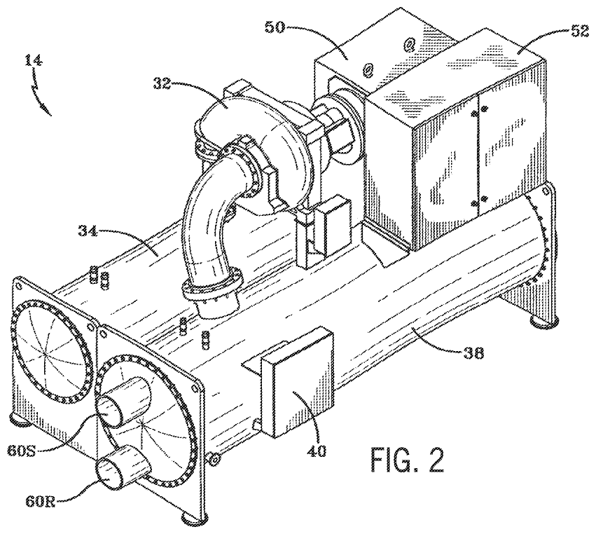

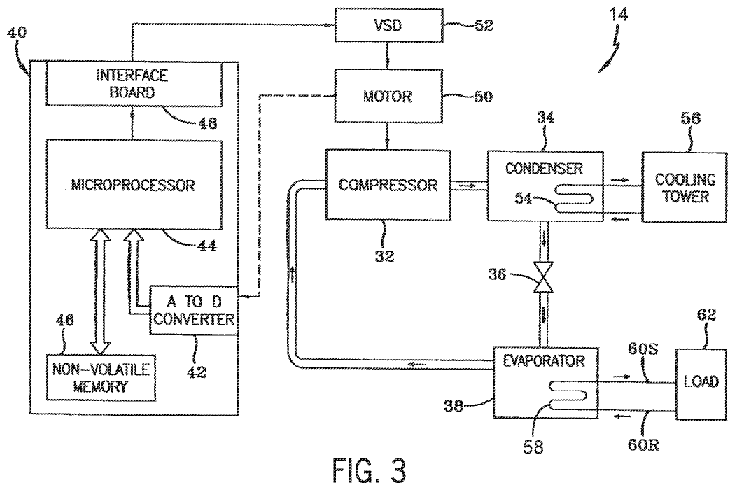

FIGS. 2 and 3 are embodiments of the vapor compression system 14 that can be used in the HVAC&R system 10. The vapor compression system 14 may circulate a refrigerant through a circuit starting with a compressor 32. The circuit may also include a condenser 34, an expansion valve(s) or device(s) 36, and a liquid chiller or an evaporator 38. The vapor compression system 14 may further include a control panel 40 (e.g., controller) that has an analog to digital (A/D) converter 42, a microprocessor 44, a non-volatile memory 46, and/or an interface board 48.

Some examples of fluids that may be used as refrigerants in the vapor compression system 14 are hydrofluorocarbon (HFC) based refrigerants, for example, R-410A, R-407, R-134a, hydrofluoro-olefin (HFO), “natural” refrigerants like ammonia (NH3), R-717, carbon dioxide (CO2), R-744, or hydrocarbon based refrigerants, water vapor, refrigerants with low global warming potential (GWP), or any other suitable refrigerant. In some embodiments, the vapor compression system 14 may be configured to efficiently utilize refrigerants having a normal boiling point of about 19 degrees Celsius (66 degrees Fahrenheit or less) at one atmosphere of pressure, also referred to as low pressure refrigerants, versus a medium pressure refrigerant, such as R-134a. As used herein, “normal boiling point” may refer to a boiling point temperature measured at one atmosphere of pressure.

In some embodiments, the vapor compression system 14 may use one or more of a variable speed drive (VSDs) 52, a motor 50, the compressor 32, the condenser 34, the expansion valve or device 36, and/or the evaporator 38. The motor 50 may drive the compressor 32 and may be powered by a variable speed drive (VSD) 52. The VSD 52 receives alternating current (AC) power having a particular fixed line voltage and fixed line frequency from an AC power source, and provides power having a variable voltage and frequency to the motor 50. In other embodiments, the motor 50 may be powered directly from an AC or direct current (DC) power source. The motor 50 may include any type of electric motor that can be powered by a VSD or directly from an AC or DC power source, such as a switched reluctance motor, an induction motor, an electronically commutated permanent magnet motor, or another suitable motor.

The compressor 32 compresses a refrigerant vapor and delivers the vapor to the condenser 34 through a discharge passage. In some embodiments, the compressor 32 may be a centrifugal compressor. The refrigerant vapor delivered by the compressor 32 to the condenser 34 may transfer heat to a cooling fluid (e.g., water or air) in the condenser 34. The refrigerant vapor may condense to a refrigerant liquid in the condenser 34 as a result of thermal heat transfer with the cooling fluid. The refrigerant liquid from the condenser 34 may flow through the expansion device 36 to the evaporator 38. In the illustrated embodiment of FIG. 3, the condenser 34 is water cooled and includes a tube bundle 54 connected to a cooling tower 56, which supplies the cooling fluid to the condenser.

The refrigerant liquid delivered to the evaporator 38 may absorb heat from another cooling fluid, which may or may not be the same cooling fluid used in the condenser 34. The refrigerant liquid in the evaporator 38 may undergo a phase change from the refrigerant liquid to a refrigerant vapor. As shown in the illustrated embodiment of FIG. 3, the evaporator 38 may include a tube bundle 58 having a supply line 60S and a return line 60R connected to a cooling load 62. The cooling fluid of the evaporator 38 (e.g., water, ethylene glycol, calcium chloride brine, sodium chloride brine, or any other suitable fluid) enters the evaporator 38 via return line 60R and exits the evaporator 38 via supply line 60S. The evaporator 38 may reduce the temperature of the cooling fluid in the tube bundle 58 via thermal heat transfer with the refrigerant. The tube bundle 58 in the evaporator 38 can include a plurality of tubes and/or a plurality of tube bundles. In any case, the refrigerant vapor exits the evaporator 38 and returns to the compressor 32 by a suction line to complete the cycle.

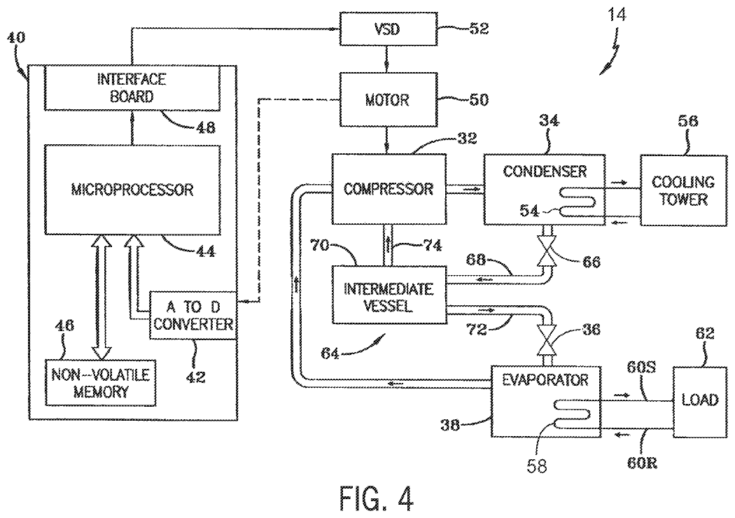

FIG. 4 is a schematic of the vapor compression system 14 with an intermediate circuit 64 incorporated between condenser 34 and the expansion device 36. The intermediate circuit 64 may have an inlet line 68 that is directly fluidly connected to the condenser 34. In other embodiments, the inlet line 68 may be indirectly fluidly coupled to the condenser 34. As shown in the illustrated embodiment of FIG. 4, the inlet line 68 includes a first expansion device 66 positioned upstream of an intermediate vessel 70. In some embodiments, the intermediate vessel 70 may be a flash tank (e.g., a flash intercooler). In other embodiments, the intermediate vessel 70 may be configured as a heat exchanger or a “surface economizer.” In the illustrated embodiment of FIG. 4, the intermediate vessel 70 is used as a flash tank, and the first expansion device 66 is configured to lower the pressure of (e.g., expand) the refrigerant liquid received from the condenser 34. During the expansion process, a portion of the liquid may vaporize, and thus, the intermediate vessel 70 may be used to separate the vapor from the liquid received from the first expansion device 66. Additionally, the intermediate vessel 70 may provide for further expansion of the refrigerant liquid because of a pressure drop experienced by the refrigerant liquid when entering the intermediate vessel 70 (e.g., due to a rapid increase in volume experienced when entering the intermediate vessel 70). The vapor in the intermediate vessel 70 may be drawn by the compressor 32 through a suction line 74 of the compressor 32. In other embodiments, the vapor in the intermediate vessel may be drawn to an intermediate stage of the compressor 32 (e.g., not the suction stage). The liquid that collects in the intermediate vessel 70 may be at a lower enthalpy than the refrigerant liquid exiting the condenser 34 because of the expansion in the expansion device 66 and/or the intermediate vessel 70. The liquid from intermediate vessel 70 may then flow in line 72 through a second expansion device 36 to the evaporator 38.

In certain embodiments, an HVAC&R system may employ multiple vapor compression systems, such as a plurality of the vapor compression systems 14, to increase a capacity of the HVAC&R system to remove thermal energy from a conditioning fluid. For example, the conditioning fluid (e.g., water or air) may be configured to flow through respective evaporators of each vapor compression system. In each evaporator, thermal energy may be transferred from the conditioning fluid to the respective refrigerants of the vapor compression systems. Thus, a greater amount of thermal energy is absorbed from the conditioning fluid in an HVAC&R system having multiple evaporators as compared to an HVAC&R system having a single evaporator.

The capacity of each refrigerant to absorb thermal energy from the conditioning fluid may be based on a capacity to cool the refrigerants in the respective vapor compression systems. For example, each vapor compression system may include a condenser configured to place refrigerant in a heat exchange relationship with a cooling fluid that absorbs thermal energy from and cools each refrigerant. In accordance with embodiments of the present disclosure, the HVAC&R system may include an additional heat exchanger that further cools at least one of the refrigerants of the multiple vapor compression systems. In one embodiment, the additional heat exchanger may place refrigerants of two different vapor compression systems in a heat exchange relationship with one another to cool one of the two refrigerants further. In another implementation, the additional heat exchanger may place at least one of the refrigerants in a heat exchange relationship with the conditioning fluid upstream of an evaporator of the respective vapor compression system. In any case, the additional heat exchanger further cools at least one of the refrigerants to enable the at least one refrigerant to absorb a greater amount of thermal energy from the conditioning fluid. As such, the HVAC&R system may remove a greater overall amount of thermal energy from the conditioning fluid.

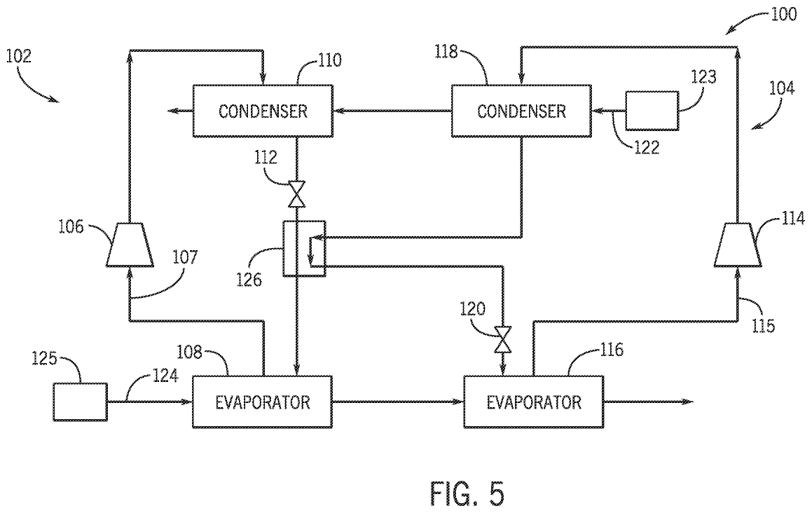

For example, FIG. 5 is a schematic of an HVAC&R system 100 having a first refrigerant circuit 102 and a second refrigerant circuit 104, in which each refrigerant circuit 102, 104 is configured to circulate a respective refrigerant. The first and second refrigerant circuits 102, 104 may be fluidly separate from one another, such that a first refrigerant of the first refrigerant circuit 102 does not mix with a second refrigerant of the second refrigerant circuit 104. As used herein, the refrigerant circuits 102, 104 each includes conduits, tubing, valves, pumps, and/or any other components that enable the respective refrigerants to be directed therethrough. The first refrigerant circuit 102 may include a first compressor 106 configured to receive a first refrigerant 107 from a first evaporator 108 (e.g., a shell-and-tube evaporator, a brazed-plate evaporator) of the first refrigerant circuit 102 and to pressurize the first refrigerant 107. The first compressor 106 may discharge the pressurized first refrigerant 107 to a first condenser 110 of the first refrigerant circuit 102. The pressurized first refrigerant 107 may be cooled in the first condenser 110 and may then flow through a first expansion valve 112 configured to reduce the pressure of the first refrigerant 107 and further cool the first refrigerant 107. The first refrigerant 107 may then be directed from the first expansion valve 112 back to the first evaporator 108.

Similarly, the second refrigerant circuit 104 may include a second compressor 114 configured to receive and pressurize a second refrigerant 115 from a second evaporator 116. The second compressor 114 may discharge the pressurized second refrigerant 115 to a second condenser 118 configured to cool the second refrigerant 115. The second refrigerant 115 may flow from the second condenser 118 toward a second expansion valve 120, which may reduce the pressure of the second refrigerant 115 and further cool the second refrigerant 115. Further, the second refrigerant 115 may be directed from the second expansion valve 120 back toward the second evaporator 116.

In some embodiments, a cooling fluid 122 may be directed from a cooling fluid source 123 to the second condenser 118 of the second refrigerant circuit 104 and then to the first condenser 110 of the first refrigerant circuit 102 in a series flow arrangement. The cooling fluid 122 may absorb thermal energy (e.g., heat) from the second refrigerant 115 in the second condenser 118 and then may absorb thermal energy from the first refrigerant 107 in the first condenser 110. As such, the cooling fluid 122 may sequentially cool the second refrigerant 115 and then the first refrigerant 107. Additionally, a conditioning fluid 124 may be directed from a conditioning fluid source 125 to the first evaporator 108 and then to the second evaporator 116 in a series flow arrangement. Thermal energy may transfer from the conditioning fluid 124 to the first refrigerant 107 in the first evaporator 108, and additional thermal energy may transfer from the conditioning fluid 124 to the second refrigerant 115 in the second evaporator 116. As such, the first refrigerant 107 and the second refrigerant 115 sequentially cool the conditioning fluid 124.

The HVAC&R system 100 may also include a heat exchanger 126 (e.g., an auxiliary heat exchanger) configured to enable thermal energy exchange between the first refrigerant 107 and the second refrigerant 115. In the illustrated embodiment, the heat exchanger 126 is included in the first refrigerant circuit 102. However, in additional or alternative embodiments, the heat exchanger 126 may be included in the second refrigerant circuit 104 or may not be included in either of the refrigerant circuits 102, 104. The heat exchanger 126 may place the first refrigerant 107 discharged from the first expansion valve 112 in a heat exchange relationship with the second refrigerant 115 exiting the second condenser 118. In other words, the first refrigerant 107 flows through the heat exchanger 126 after the first refrigerant 107 is cooled via the first condenser 110 and the first expansion valve 112, and the second refrigerant 115 flows through the heat exchanger 126 after the second refrigerant 115 is cooled via the second condenser 118. In some embodiments, the second refrigerant 115 exiting the heat exchanger 126 is then directed to the second expansion valve 120. In other embodiments, the second refrigerant 115 may be directed to the heat exchanger 126 after exiting the second expansion valve 120. In any case, the first refrigerant 107 in the heat exchanger 126 may have a lower temperature than the second refrigerant 115. Therefore, the heat exchanger 126 may function as an economizer, in which the first refrigerant 107 absorbs thermal energy from the second refrigerant 115, thereby heating the first refrigerant 107 and cooling the second refrigerant 115.

In some embodiments, the first expansion valve 112 expands and cools the first refrigerant 107 such that the first refrigerant 107 enters the heat exchanger 126 at a first initial temperature. The second condenser 118 may cool the second refrigerant 115 such that the second refrigerant 115 enters the heat exchanger 126 at a second initial temperature, in which the second initial temperature is greater than the first initial temperature. As a result, the first refrigerant 107 absorbs thermal energy from the second refrigerant 115 to increase the temperature of the first refrigerant 107 and to reduce the temperature of the second refrigerant 115. The first refrigerant 107 may be primarily in a vaporous or gaseous state in the heat exchanger 126, whereas the second refrigerant 115 may be primarily in a liquid state in the heat exchanger 126. Adding thermal energy to, or removing thermal energy from, a refrigerant in a vaporous state may not affect a temperature of the refrigerant significantly when compared to adding thermal energy to, or removing thermal energy from, a refrigerant of a liquid state. Thus, in the heat exchanger 126, the thermal energy exchanged between the first refrigerant 107 and the second refrigerant 115 may reduce the temperature of the second refrigerant 115 without substantially increasing the temperature of the first refrigerant 107. As a result, the second refrigerant 115 discharged from the heat exchanger 126 may have a greater capacity to absorb thermal energy from the conditioning fluid 124 in the second evaporator 116 without substantially impacting the capacity of the first refrigerant 107 to absorb thermal energy from the conditioning fluid 124 in the first evaporator 108. The second expansion valve 120 may then expand and further reduce the temperature of the second refrigerant 120 before the second refrigerant 120 enters the second evaporator 116. As a result, the first refrigerant 107 may be preheated before entering the first evaporator 108 and may substantially vaporize at a first evaporation temperature in the first evaporator 108. Additionally, the second refrigerant 115 may substantially vaporize at a second evaporation temperature in the second evaporator 116, where the second evaporation temperature is less than the first evaporation temperature. Therefore, including the heat exchanger 126 in the first refrigerant circuit 102 may increase an overall amount of thermal energy removed from the conditioning fluid 124 via the first evaporator 108 and the second evaporator 116.

In additional or alternative embodiments, the heat exchanger 126 may place the first refrigerant 107 in a heat exchange relationship with the second refrigerant 115, such that the second refrigerant 115 absorbs thermal energy from the first refrigerant 107. In such embodiments, the temperature of the first refrigerant 107 may be reduced, and the temperature of the second refrigerant 115 may increase. Using similar techniques to those described above, the heat exchanger 126 may increase the capacity of the first refrigerant 107 to absorb thermal energy from the conditioning fluid 124 in the first evaporator 108 without substantially impacting the capacity of the second refrigerant 115 to absorb thermal energy from the conditioning fluid in the second evaporator 116. Accordingly, the heat exchanger 126 may still increase an overall amount of thermal energy that may be removed from the conditioning fluid 124 via the first evaporator 108 and the second evaporator 116.

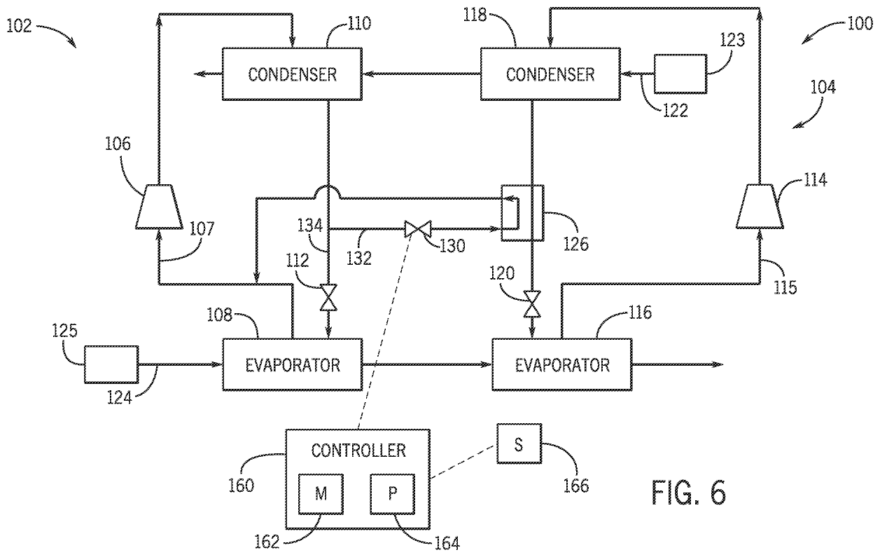

FIG. 6 is a schematic of another embodiment of the HVAC&R system 100 having the first refrigerant circuit 102, the second refrigerant circuit 104, and the heat exchanger 126. In the illustrated embodiment, an operating parameter of the first refrigerant 107 directed through the heat exchanger 126 may be controlled (e.g., via a controller 160). For example, the first refrigerant circuit 102 may include a third expansion valve 130 configured to reduce a pressure of a first portion 132 of the first refrigerant 107 and enable a flow of the first portion 132 from the first condenser 110 to the heat exchanger 126. The first portion 132 may then exchange heat with the second refrigerant 115 in the heat exchanger 126 and be directed from the heat exchanger 126 toward the first compressor 106 (e.g., a position along the first refrigerant circuit 102 upstream of the first compressor 106). A second portion or remaining portion 134 of the first refrigerant 107 may bypass the heat exchanger 126 and be directed from the first condenser 110 to the first evaporator 108 to exchange heat with the conditioning fluid 124.

A position of the third expansion valve 130 may control the pressure and/or flow rate of the first portion 132 directed through heat exchanger 126. The change of the pressure and/or flow rate of the first portion 132 may change an amount of heat exchanged between the first portion 132 of the first refrigerant 107 and the second refrigerant 115 in the heat exchanger 126, such as an amount of cooling performed on the second refrigerant 115. Thus, in some embodiments, the third expansion valve 130 may be adjusted based on a target amount of cooling of the second refrigerant 115. For example, the third expansion valve 130 may be an electronic expansion valve communicatively coupled to the controller 160 of the HVAC&R system 100. The controller 160 may include a memory 162 and a processor 164. The memory 162 may be a mass storage device, a flash memory device, removable memory, or any other non-transitory computer-readable medium that includes instructions for controlling of the HVAC&R system 100. The memory 162 may also include volatile memory, such as randomly accessible memory (RAM) and/or non-volatile memory, such as hard disc memory, flash memory, and/or other suitable memory formats. The processor 164 may execute the instructions stored in the memory 162, such as to control the position of the third expansion valve 130 and adjust an amount (e.g., a volumetric flow rate) of the first portion 132 of the first refrigerant 107 directed to the heat exchanger 126. As an example, the controller 160 may be configured to adjust the third expansion valve 130 to reduce the pressure and/or flow rate of the first portion 132 to increase an amount of cooling of the second refrigerant 115 directed through the heat exchanger 126. The controller 160 may alternatively adjust the position of the third expansion valve 130 to increase the pressure and/or flow rate of the first portion 132 to reduce an amount of the cooling of the second refrigerant 115 directed through the heat exchanger 126. As such, the position of the third expansion valve 130 may be adjusted to change an amount (e.g., a volumetric flow rate) of the first portion 132 of the first refrigerant 107 directed through the heat exchanger 126 to control an amount of heat exchanged between the first refrigerant 107 and the second refrigerant 115 in the heat exchanger 126.

In some embodiments, the controller 160 may be configured to adjust the position of the third expansion valve 130 based on an operating parameter of the HVAC&R system 100. For instance, the controller 160 may be communicatively coupled to a sensor 166 that is configured to provide feedback indicative of the operating parameter. The operating parameter may include a target temperature and/or pressure of the conditioning fluid 124 (e.g., a temperature of the conditioning fluid 124 exiting the first evaporator 108 and/or exiting the second evaporator 116), a temperature and/or pressure of the first refrigerant 107 (e.g., entering and/or exiting the heat exchanger 126), a temperature of the second refrigerant 115 (e.g., entering and/or exiting the heat exchanger 126), another suitable operating parameter, or any combination thereof. The sensor 166 may transmit feedback indicative of the operating parameter to the controller 160, and the controller 160 may adjust the position of the third expansion valve 130 based on the feedback. In additional or alternative embodiments, the third expansion valve 130 may be a thermal expansion valve that may automatically control the flow of the first portion 132 from the first condenser 110 to the heat exchanger 126 based on a property of the first refrigerant 107 without using the controller 160.

Although FIG. 6 illustrates that the first refrigerant 107 directed from the first condenser 110 may be split into the first portion 132 and the second portion 134, the second refrigerant 115 directed from the second condenser 118 may additionally or alternatively be split into two portions. For example, the second refrigerant 115 directed from the second condenser 118 may be split into a third portion, which may be directed from the second condenser 118 to the heat exchanger 126 (e.g., positioned along the first refrigerant circuit 102 and/or the second refrigerant circuit 104), and a fourth portion or remaining portion, which may be directed from the second condenser 118 directly to the second evaporator 116 (e.g., the fourth portion or remaining portion bypasses the heat exchanger 126). The controller 160 may be configured to adjust a position of an additional valve to control an amount (e.g., a flow rate) of the third portion directed to the heat exchanger 126, such as based on any of the operating parameters mentioned above, to adjust an amount of cooling of the second refrigerant 115.

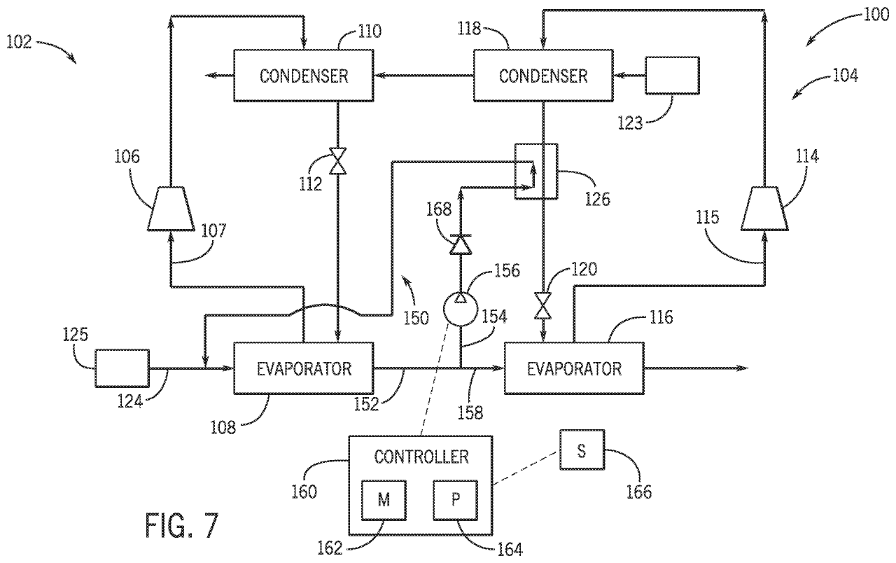

FIG. 7 is a schematic of an embodiment of the HVAC&R system 100 having the first refrigerant circuit 102 and the second refrigerant circuit 104. In the illustrated embodiment, the heat exchanger 126 is included within the second refrigerant circuit 104, but in additional or alternative embodiments, the heat exchanger 126 may be included in the first refrigerant circuit 102 (e.g., the embodiment of FIG. 5). As shown in FIG. 7, the heat exchanger 126 may place the second refrigerant 115 exiting the second condenser 118 in a heat exchange relationship with the conditioning fluid 124 exiting the first evaporator 108. In other words, the heat exchanger 126 may receive the second refrigerant 115 exiting the second condenser 118 and may receive at least a portion of the conditioning fluid 124 from the first evaporator 108. In some embodiments, the conditioning fluid 124 in the heat exchanger 126 may have a lower temperature than the second refrigerant 115 and, thus, the conditioning fluid 124 may absorb thermal energy from the second refrigerant 115. As such, the heat exchanger 126 may act as an economizer, in which the conditioning fluid 124 is heated and the second refrigerant 115 is cooled.

As shown in the illustrated embodiment of FIG. 7, the HVAC&R system 100 includes a conditioning fluid circuit 150 configured to direct conditioning fluid 124 from the first evaporator 108 to the heat exchanger 126. In some embodiments, an entire amount 152 of the conditioning fluid 124 discharged from the first evaporator 108 may be directed to the heat exchanger 126. In other embodiments, a first portion 154 of the conditioning fluid 124 discharged from the first evaporator 108 may be directed to the heat exchanger 126 (e.g., via a pump 156), and a remaining second portion 158 of the conditioning fluid 124 discharged from the first evaporator 108 is directed to the second evaporator 116 to be cooled by the second refrigerant 115. After the first portion 154 is heated in the heat exchanger 126, the conditioning fluid circuit 150 may direct the first portion 154 from the heat exchanger 126 to the first evaporator 108, such as to a location between the conditioning fluid source 125 and the first evaporator 108. Thus, the heated first portion 154 of the conditioning fluid 124 is combined with the conditioning fluid 124 from the conditioning fluid source 125 prior to entering the first evaporator 108. As such, the heated first portion 154 may be re-cooled via heat exchange with the first refrigerant 107 in the first evaporator 108.

The HVAC&R system 100 may also include the controller 160, which may be communicatively coupled to the pump 156, which may direct the first portion 154 of conditioning fluid 124 to the heat exchanger 126. The controller 160 may transmit a signal to adjust an amount of conditioning fluid 124, such as a volumetric flow rate, in the first portion 154 that is directed to the heat exchanger 126. For instance, the controller 160 may be communicatively coupled to the sensor 166, which is configured to provide feedback indicative of an operating parameter of the HVAC&R system 100, such as a temperature of the first refrigerant 107 and/or the second refrigerant 115, a temperature of the conditioning fluid 124, a target temperature of the conditioning fluid 124 exiting the second evaporator 116, another suitable operating parameter, or any combination thereof. Based on the feedback from the sensor 166, the controller 160 may transmit a signal to adjust operation of the pump 156 (e.g., a speed of the pump and/or a discharge pressure of the pump) to adjust an amount of the conditioning fluid 124 directed to the heat exchanger 126, which may affect an amount of cooling to the second refrigerant 115. For example, increasing the amount of conditioning fluid 124 in the first portion 154 directed to the heat exchanger 126 may increase cooling of the second refrigerant 115 in the heat exchanger 126. In additional or alternative embodiments, the controller 160 may transmit a signal to adjust the operation of the pump 156 based on user feedback indicative of a target temperature of the conditioning fluid 124 exiting the second evaporator 116.

In some embodiments, the HVAC&R system 100 may operate without utilizing the conditioning fluid 124 to cool the second refrigerant 115 within the heat exchanger 126. For example, sufficient cooling of the conditioning fluid 124 may be achieved without operating the pump 156 and/or without directing the first portion 154 of the conditioning fluid 124 to the heat exchanger 126. Thus, the controller 160 may suspend or disable operation of the pump 156, which may reduce energy consumption of the HVAC&R system 100. When the pump 156 is suspended or disabled, the HVAC&R system 100 may operate in a first operating mode, in which the conditioning fluid 124 is directed from the first evaporator 108 to the second evaporator 116 in a series flow arrangement and in which the conditioning fluid 124 is blocked from flowing through the conditioning fluid circuit 150 to the heat exchanger 126. Alternatively, when the pump 156 is in operation, the HVAC&R system 100 may be operating in a second operating mode, in which the first portion 154 of conditioning fluid 124 is directed to the heat exchanger 126 to cool the second refrigerant 115. In the second operating mode, the HVAC&R system 100 is configured to increase cooling of the conditioning fluid 124 by placing the second portion 158 of the conditioning fluid 124 in thermal communication with the second refrigerant 115, which is previously cooled in the heat exchanger 126, in the second evaporator 116.

Additionally, the conditioning fluid circuit 150 may include a valve 168 configured to enable a flow of the conditioning fluid 124 from the pump 156 to the heat exchanger 126 (e.g., in the second operating mode) in an open position and configured to block a flow of conditioning fluid 124 to the heat exchanger 126 in a closed position. Further, the valve 168 may block a flow of the conditioning fluid 124 from bypassing the first evaporator 108 via a flow from the conditioning fluid source 125 to the heat exchanger 126. In some embodiments, the valve 168 may be a check valve that enables the conditioning fluid 124 to flow in a single direction (e.g., from the pump 156 to the heat exchanger 126). In other embodiments, the valve 168 may be a two-way valve configured to transition between an open position that enables fluid flow through the valve 168 and a closed position that blocks fluid flow through the valve 168. In such embodiments, the valve 168 may be communicatively coupled to the controller 160, such that the controller 160 may transmit a signal to adjust the position of the valve 168. For example, the controller 160 may transmit a signal to adjust the valve 168 to be in the closed position when the pump 156 is not in operation and may adjust the valve 168 to be in the open position when the pump 156 is in operation. The controller 160 may also transmit a signal to adjust the valve 168 to control a flow rate of conditioning fluid 124 directed through the valve 168, and therefore to the heat exchanger 126, to adjust the amount of cooling of the second refrigerant 115 in the heat exchanger 126.

Additionally, in certain embodiments, the HVAC&R system 100 may include the heat exchanger 126 of FIG. 7 and the heat exchanger 126 of FIG. 5 (e.g., the HVAC&R system 100 includes the heat exchanger 126 in both the first refrigerant circuit 102 and the second refrigerant circuit 104). In other words, the HVAC&R system 100 may include two additional heat exchangers 126. One additional heat exchanger 126 may be configured to place the first and second refrigerants 107, 115 in a heat exchange relationship with one another to cool the second refrigerant 115, as described above with reference to FIG. 5. Another additional heat exchanger 126 may be configured to place the second refrigerant 115 in a heat exchange relationship with the first portion 154 of the conditioning fluid 124 to cool the second refrigerant 115 further, as described above with reference to FIG. 7. Thus, in an embodiment of the HVAC&R system 100 having two additional heat exchangers 126, the second refrigerant 115 may be cooled by a greater amount when compared to an embodiment of the HVAC&R system 100 having one additional heat exchanger 126.

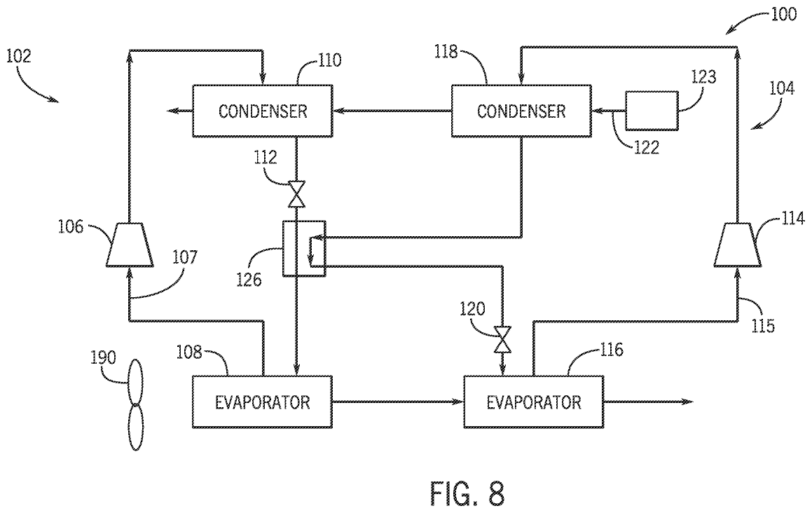

It should be noted that any of the embodiments of the HVAC&R system 100 illustrated in FIGS. 5-7 may utilize air as the conditioning fluid 124 (e.g., air exchanges heat with the first refrigerant 107 and/or the second refrigerant 115 via the first evaporator 108 and/or the second evaporator 116, respectively). For example, FIG. 8 is a schematic of another embodiment of the HVAC&R system 100 having the first refrigerant circuit 102, the second refrigerant circuit 104, and the heat exchanger 126, similar to the HVAC&R system 100 depicted in FIG. 5. As shown in the illustrated embodiment of FIG. 8, a fan 190 may be used to force or draw air through the first evaporator 108 and/or the second evaporator 116. The first evaporator 108 may be configured to place the air in a heat exchange relationship with the first refrigerant 107 and then the second evaporator 116 may be configured to place the air in a heat exchange relationship with the second refrigerant 115, thereby conditioning the air. As such, the first evaporator 108 and the second evaporator 116 of the HVAC&R system 100 of FIG. 8 may be air to liquid heat exchangers. The conditioned air exiting the second evaporator may then be directed to an environment of a structure to condition the structure (e.g., directed into the environment via ductwork of the structure).

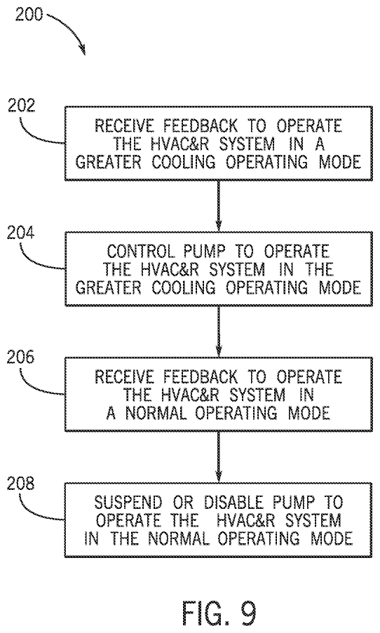

FIG. 9 is a block diagram illustrating an embodiment of a method or process 200 to operate the HVAC&R system 100 having the conditioning fluid circuit 150. In certain embodiments, the method 200 may be performed by one or more controllers, such as the controller 160. In FIG. 9, the method 200 is described with reference to the embodiment of the HVAC&R system 100 shown in FIG. 7. However, a similar method or process may additionally or alternatively be performed in other embodiments of the HVAC&R system 100, such as the HVAC&R system 100 in FIG. 5. Furthermore, steps may be performed in addition to the method 200, and/or certain steps of the depicted method 200 may be modified, removed, and/or performed in a different order than shown in FIG. 9.

At block 202, the controller 160 receives feedback indicative of an operating parameter of the HVAC&R system 100. For example, the feedback indicative of the operating parameter of the HVAC&R system 100 may include a temperature of the first refrigerant 107 and/or the second refrigerant 115, a temperature of the conditioning fluid 124, a target temperature of the conditioning fluid 124 exiting the second evaporator 116, another suitable operating parameter, or any combination thereof. To this end, the feedback indicative of the operating parameter of the HVAC&R system 100 may be received by the controller 160 via the sensor 166. In some embodiments, the controller 160 may compare the feedback to a threshold value or range and, based on the comparison (e.g., the feedback exceeds the threshold value), may determine that the HVAC&R system 100 should operate in the second operating mode described above. In still further embodiments, the feedback may be received from a user, such as from an operator of the HVAC&R system 100. That is, the user may input a target operating parameter (e.g., a temperature of the conditioning fluid 124 exiting the second evaporator 116) that causes the controller 160 to operate the HVAC&R system 100 in the second operating mode.

When the controller 160 determines that the HVAC&R system 100 should operate in the second operating mode, the controller 160 may transmit a signal to activate the pump 156 to direct the first portion 154 of the conditioning fluid 124 exiting the first evaporator 108 to the heat exchanger 126, as shown at block 204. As a result, the first portion 154 of the conditioning fluid 124 absorbs thermal energy from the second refrigerant 115 in the heat exchanger 126 to cool the second refrigerant 115. In this manner, the second refrigerant 115 may exit the heat exchanger 126 with an increased cooling capacity for reducing a temperature of the conditioning fluid 124 in the second evaporator 116. In certain embodiments, the controller 160 may also transmit a signal to adjust operation of the pump 156 (e.g., a speed of the pump 156) to control an amount of conditioning fluid 124 directed to the heat exchanger 126 (e.g., an amount of the first portion 154), which may adjust an amount of cooling of the second refrigerant 115 in the heat exchanger 126. As set forth above, increasing a flow rate of the conditioning fluid 124 to the heat exchanger 126 may further cool the second refrigerant 115, thereby increasing a cooling capacity of the HVAC&R system 100. Additionally or alternatively, the controller 160 may transmit a signal to adjust a position of the valve 168 based on the feedback to direct a target flow rate of the conditioning fluid 124 to the heat exchanger 126.

At block 206 the controller 160 receives additional feedback indicative of an additional operating parameter of the HVAC&R system 100. For instance, the additional feedback may be indicative of an additional temperature of the first refrigerant 107 and/or the second refrigerant 115, an additional temperature of the conditioning fluid 124, the target temperature of the conditioning fluid 124 exiting the second evaporator 116, another suitable operating parameter, or any combination thereof. The controller 160 may compare the additional feedback to the threshold value or range and/or an additional threshold value or range. Based on the comparison (e.g., the additional feedback is below the threshold value), the controller 160 may determine that the HVAC&R system 100 should operate in the first operating mode. The additional feedback may also be an input from the user indicative of a target operating parameter that enables the controller 160 to determine that the HVAC&R system 100 should operate in the first operating mode.

When the controller 160 determines that the HVAC&R system 100 should operate in the first operating mode, the controller 160 may suspend or disable operation of the pump 156, such that the conditioning fluid 124 does not flow through the conditioning fluid circuit 150, as indicated by block 208. As such, the conditioning fluid 124 does not absorb thermal energy from the second refrigerant 115 in the heat exchanger 126. In some embodiments, the controller 160 may also transmit a signal to adjust a position of the valve 168 to block the conditioning fluid 124 from flowing through the conditioning fluid circuit 150 (e.g., from the conditioning fluid source to the conditioning fluid circuit 150 and/or from the first evaporator 108 to the heat exchanger 126).

Embodiments of the present disclosure are directed to an HVAC&R system having multiple vapor compression systems, in which each vapor compression system is configured to circulate a refrigerant. Each vapor compression system may include a first heat exchanger, such as an evaporator, configured to place a refrigerant in a heat exchange relationship with a conditioning fluid directed through the HVAC&R system to cool the conditioning fluid. Each vapor compression system may include a second heat exchanger, such as a condenser, configured to place the refrigerant in a heat exchange relationship with a cooling fluid directed through the HVAC&R system to cool the refrigerant. The HVAC&R system may further include an additional heat exchanger, such as an economizer, configured to cool at least one of the refrigerants further. In some embodiments, the additional heat exchanger may place the respective refrigerants in a heat exchanger relationship with one another to enable thermal energy (e.g., heat) to exchange between the refrigerants. In additional or alternative embodiments, the additional heat exchanger may place one of the refrigerants in an additional heat exchange relationship with the conditioning fluid, such that the conditioning fluid increases a cooling capacity of the refrigerant. By further cooling of at least one of the refrigerants, the additional heat exchanger may enable that refrigerant to remove a greater amount of thermal energy from the conditioning fluid in an evaporator of the vapor compression system circulating that refrigerant. As such, the additional heat exchanger may enable the HVAC&R system to remove a greater overall amount of thermal energy from the conditioning fluid and improve performance of the HVAC&R system. The technical effects and technical problems in the specification are examples and are not limiting. It should be noted that the embodiments described in the specification may have other technical effects and can solve other technical problems.

While only certain features and embodiments of the disclosure have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the exemplary embodiments, all features of an actual implementation may not have been described (i.e., those unrelated to the presently contemplated best mode of carrying out the disclosure, or those unrelated to enabling the claimed disclosure). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A heating, ventilation, air conditioning, and/or refrigeration (HVAC&R) system, comprising:
a first refrigerant circuit comprising a first compressor configured to circulate a first refrigerant through a first condenser and a first evaporator;
a second refrigerant circuit comprising a second compressor configured to circulate a second refrigerant through a second condenser and a second evaporator; and
a heat exchanger configured to place the first refrigerant in a heat exchange relationship with the second refrigerant;
wherein the first refrigerant circuit is configured to direct the first refrigerant from the first condenser to the heat exchanger and from the heat exchanger to the first evaporator, and the second refrigerant circuit is configured to direct the second refrigerant from the second condenser to the heat exchanger and from the heat exchanger to the second evaporator.

2. The HVAC&R system of claim 1, wherein the first evaporator is configured to substantially vaporize the first refrigerant at a first evaporation temperature, the second evaporator is configured to substantially vaporize the second refrigerant at a second evaporation temperature, the first temperature is greater than the second temperature, and the heat exchanger is configured to enable thermal energy transfer from the second refrigerant to the first refrigerant.

3. The HVAC&R system of claim 1, wherein the first evaporator is configured to place the first refrigerant in a first heat exchange relationship with a conditioning fluid, and the second evaporator is configured to place the second refrigerant in a second heat exchange relationship with the conditioning fluid.

4. The HVAC&R system of claim 3, wherein the first refrigerant circuit comprises a first expansion valve configured to direct the first refrigerant from the first condenser to the heat exchanger, and the second refrigerant circuit comprises a second expansion valve configured to direct the second refrigerant from the heat exchanger to the second evaporator.

5. The HVAC&R system of claim 4, wherein the heat exchanger is configured to receive the first refrigerant from the first expansion valve, and wherein the second expansion valve is configured to receive the second refrigerant exiting the heat exchanger.

6. The HVAC&R system of claim 4, wherein the first expansion valve is configured to direct a first portion of the first refrigerant from the first condenser to the heat exchanger, and the HVAC&R system comprises a third expansion valve configured to direct a second portion of the refrigerant to bypass the heat exchanger and flow from the first condenser to the first evaporator.

7. The HVAC&R system of claim 3, wherein the second condenser and the first condenser are arranged in a series flow arrangement relative to a flow of a cooling fluid through the second condenser and the first condenser, and wherein the first evaporator and the second evaporator are arranged in a series flow arrangement relative to a flow of the conditioning fluid through the first heat exchanger and the second heat exchanger.

8. A heating, ventilation, air conditioning, and/or refrigeration (HVAC&R) system, comprising:
a first refrigerant circuit configured to circulate a first refrigerant, wherein the first refrigerant circuit comprises a first evaporator configured to place the first refrigerant in a first heat exchange relationship with a conditioning fluid;
a second refrigerant circuit configured to circulate a second refrigerant, wherein the second refrigerant circuit comprises a second evaporator configured to place the second refrigerant in a second heat exchange relationship with the conditioning fluid; and
a heat exchanger configured to place the second refrigerant in a third heat exchange relationship with the conditioning fluid discharged from the first evaporator.

9. The HVAC&R system of claim 8, comprising a conditioning fluid circuit configured to direct the conditioning fluid discharged from the first evaporator to the heat exchanger.

10. The HVAC&R system of claim 9, wherein the conditioning fluid circuit is configured to direct the conditioning fluid from the heat exchanger toward the first evaporator.

11. The HVAC&R system of claim 9, wherein the conditioning fluid circuit comprises a valve configured to block the conditioning fluid from flowing to the second evaporator from the heat exchanger.

12. The HVAC&R system of claim 9, comprising a pump disposed along the conditioning fluid circuit and comprising a controller configured to transmit a signal to adjust a speed of the pump to control an amount of the conditioning fluid directed to the heat exchanger from the first evaporator.

13. The HVAC&R system of claim 8, wherein the first evaporator and the second evaporator are arranged in a series flow arrangement relative to a flow of the conditioning fluid through the first evaporator and the second heat evaporator.

14. The HVAC&R system of claim 13, comprising a conditioning fluid circuit configured to direct a first portion of the conditioning fluid discharged from the first evaporator to the heat exchanger, and a second portion of the conditioning fluid discharged from the first evaporator is directed to the second evaporator.

15. A heating, ventilation, air conditioning, and/or refrigeration (HVAC&R) system, comprising:
a first refrigerant circuit configured to circulate a first refrigerant and place the first refrigerant in a first heat exchange relationship with a conditioning fluid;
a second refrigerant circuit configured to circulate a second refrigerant and configured to place the second refrigerant in a second heat exchange relationship with the conditioning fluid, wherein the first refrigerant circuit and the second refrigerant circuit are fluidly separate from one another relative to a first flow of the first refrigerant and a second flow of the second refrigerant; and
one or more heat exchangers configured to place the second refrigerant in a third heat exchange relationship with the conditioning fluid, the first refrigerant, or both.

16. The HVAC&R system of claim 15, wherein the one or more heat exchangers is configured to place the second refrigerant in the third heat exchange relationship with the first refrigerant, and wherein the one or more heat exchangers is configured to receive the second refrigerant from a condenser of the second refrigerant circuit and to receive the first refrigerant from an expansion valve of the first refrigerant circuit.

17. The HVAC&R system of claim 16, wherein the expansion valve is a first expansion valve, and wherein the second refrigerant circuit comprises a second expansion valve configured to receive the second refrigerant from the one or more heat exchangers.

18. The HVAC&R system of claim 15, wherein the one or more heat exchangers is configured to place the second refrigerant in the third heat exchange relationship with the conditioning fluid, and wherein the one or more heat exchangers is configured to receive the second refrigerant from a condenser of the second refrigerant circuit and to receive at least a portion of the conditioning fluid from an evaporator of the first refrigerant circuit.

19. The HVAC&R system of claim 18, wherein the HVAC&R system comprises a pump and a conditioning fluid circuit configured to direct the portion of the conditioning fluid from the evaporator to the heat exchanger.

20. The HVAC&R system of claim 19, wherein the portion of the conditioning fluid is a first portion of the conditioning fluid, the evaporator is a first evaporator, and the HVAC&R system is configured to direct a second portion of the conditioning fluid from the first evaporator to a second evaporator of the second refrigerant circuit.
